(19) United States
(12) Patent Application Publication
(10) Pub. No.: US 2022/0413512 A1
(43) Pub. Date: Dec. 29, 2022

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventor: TATSUKI KASHITANI, TOKYO (JP)

(21) Appl. No.: 17/756,195

(22) PCT Filed: Oct. 9, 2020
(86) PCT No.: PCT/JP2020/038327

§ 371 Date: May 19, 2022

(30) Foreign Application Priority Data
Nov. 29, 2019 (JP) 2019-215976

(51) Int. Cl. G05D 1/02; G06F 16/53

(52) U.S. Cl. CPC G05D 1/0274; G05D 1/0246; G06F 16/53

(57) ABSTRACT

To provide an information processing device configured to: acquire correspondence information between a key frame and a query image, the key frame being disposed in advance on map data; and combine a plurality of pieces of the map data on the basis of the correspondence information.

### TECHNICAL FIELD

The present technology relates to an information processing device, an information processing method, and an information processing program.

### BACKGROUND ART

Recently, proposed has been a technique for moving a movable object such as a vehicle, drone, or robot to acquire its peripheral information and map information. In addition, proposed has been a technique for combining information acquired by individual movable objects (refer to Patent Document 1).

### CITATION LIST

### Patent Document

Patent Document 1: Japanese Patent Application Laid-Open No. 2017-90239

### SUMMARY OF THE INVENTION

### Problems to be Solved by the Invention

In use of a plurality of movable objects, because each of the movable objects independently acquires its peripheral information and map information, the location and pose of each movable object are estimated on the basis of a different origin point for each piece of information. Thus, it is difficult to grasp the distance and direction from one movable object to another movable object, resulting in leading to a difficulty in accurately combining a plurality of pieces of information.

The present technology has been made in view of such a point, and an object of the present technology is to provide an information processing device, an information processing method, and an information processing program that enable combining a plurality of pieces of map data.

### Solutions to Problems

In order to solve the above disadvantage, according to a first technology, provided is an information processing device configured to: acquire correspondence information between a key frame and a query image, the key frame being disposed in advance on map data; and combine a plurality of pieces of the map data on the basis of the correspondence information.

Further, according to a second technology, provided is an information processing method including: acquiring correspondence information between a key frame and a query image, the key frame being disposed in advance on map data; and combining a plurality of pieces of the map data on the basis of the correspondence information.

Furthermore, according to a third technology, provided is an information processing program for causing a computer to perform an information processing method including: acquiring correspondence information between a key frame and a query image, the key frame being disposed in advance on map data; and combining a plurality of pieces of the map data on the basis of the correspondence information.

### BRIEF DESCRIPTION OF DRAWINGS

FIG. 1 is a block diagram illustrating the configuration of an information processing system 10.

FIG. 2 is a block diagram illustrating the configuration of a movable object 100.

FIG. 3 is a block diagram illustrating the configuration of an information processing device 200.

FIG. 4 is a flowchart illustrating processing in the movable object 100.

FIG. 5 is an explanatory illustration of hash value generation.

FIG. 6 is an explanatory illustration of the hash value generation.

FIG. 7 is a flowchart illustrating processing in the information processing device 200.

FIG. 8 is an illustration of exemplary first map data and second map data.

FIG. 9 is an explanatory illustration of map-data combination processing.

FIG. 10 is an explanatory illustration of the map-data combination processing.

FIG. 11 is an explanatory illustration of the map-data combination processing.

FIG. 12 is an illustration of combined map data created due to combination of the first map data and the second map data.

FIG. 13 is an explanatory diagram of a modification.

### MODE FOR CARRYING OUT THE INVENTION

Hereinafter, embodiments of the present technology will be described with reference to the drawings. Note that the description will be given in the following order.

<1. Embodiment>

[1-1. Configuration of Information Processing System 10]

[1-2. Configuration of Movable Object 100]

[1-3. Configuration of Information Processing Device 200]

[1-4. Processing in Movable Object 100]

[1-5. Processing in Information Processing Device 200]

<2. Modifications>

### 1. Embodiment

[1-1. Configuration of Information Processing System 10]

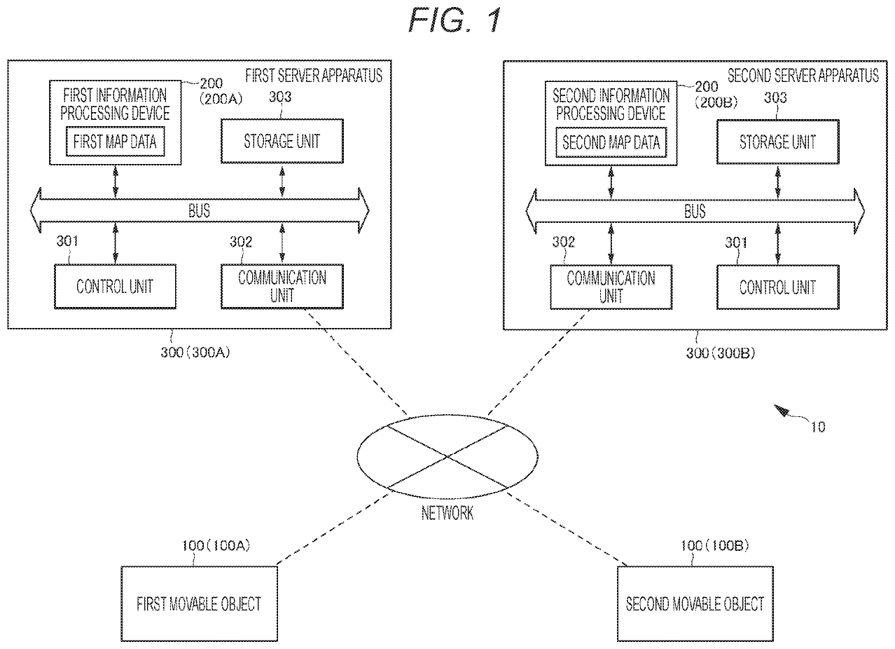

First, the configuration of an information processing system 10 according to an embodiment of the present technology will be described with reference to FIG. 1. The information processing system 10 includes a plurality of movable objects 100 and a plurality of information processing devices 200. In the present embodiment, it is assumed that a first movable object 100A and a second movable object 100B are each provided as a movable object 100, and a first information processing device 200A and a second information processing device 200B are each provided as an information processing device 200.

It is assumed that the first information processing device 200A operates in a first server apparatus 300A and the second information processing device 200B operates in a second server apparatus 300B. The movable objects 100 and the server apparatuses 300 each including the corresponding information processing device 200 are connected through a network such as the Internet.

Each of the movable objects 100 may be any device that moves independently, such as a drone, a robot vacuum cleaner, a pet robot, a humanoid robot, an automated driving vehicle, and an autonomous delivery robot. Further, the movable objects 100 each have a simultaneous localization and mapping (SLAM) function to create map data regarding the surroundings of the movable object 100 and perform self localization. Note that the number of movable objects 100 included in the information processing system 10 is not limitative.

An information processing device 200 holds map data created by a movable object 100 and performs map-data combination processing. In the present embodiment, it is assumed that an information processing device 200 stores a plurality of pieces of map data created by each of the plurality of movable objects 100 with SLAM.

The first movable object 100A is associated with the first information processing device 200A, and the first information processing device 200A stores first map data created by the first movable object 100A. In contrast, the second movable object 100B is associated with the second information processing device 200B, and the second information processing device 200B stores second map data created by the second movable object 100B.

The server apparatuses 300 each include at least a control unit 301, a communication unit 302, and a storage unit 303. The information processing devices 200 each communicate with the corresponding movable object 100 through the communication unit 302 included in the server apparatus 300.

The control units 301 each include a central processing unit (CPU), a read only memory (ROM), and a random access memory (RAM). The ROM stores, for example, programs to be read and operated by the CPU. The RAM is used as a work memory of the CPU. The CPU issues commands by executing various pieces of processing in accordance with such a program stored in the ROM to control the entire server apparatus and each unit of the server apparatus.

The communication units 302 are each a communication module for communication with a movable object or another server apparatus. Examples of the communication scheme include a wireless local area network (LAN), a wide area network (WAN), wireless fidelity (WiFi), the fourth generation mobile communication system (4G), the fifth generation mobile communication system (5G), Bluetooth (registered trademark), and ZigBee (registered trademark).

The storage units 303 are each, for example, a large-capacity storage medium such as a hard disk or a flash memory.

It is assumed that the first information processing device 200A operates in the first server apparatus 300A and the second information processing device 200B operates in the second server apparatus 300B.

[1-2. Configuration of Movable Object 100]

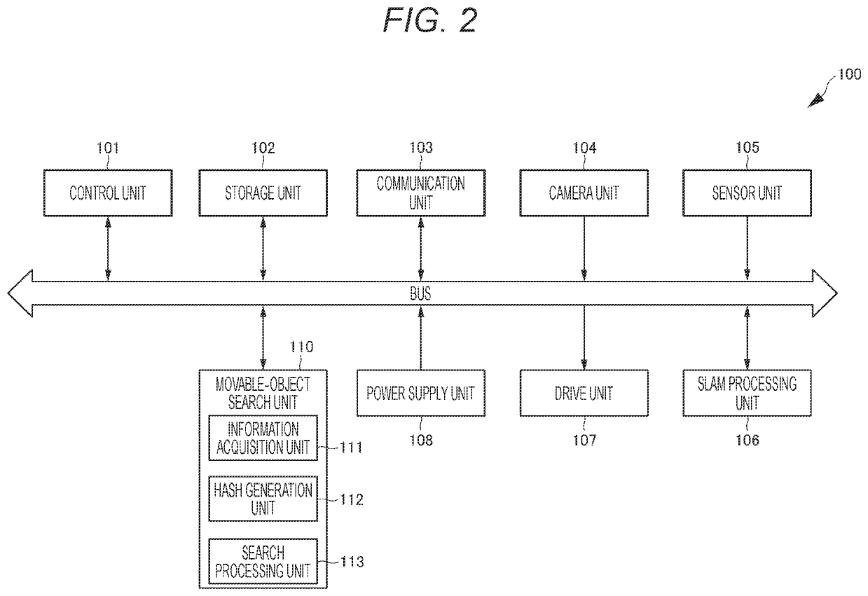

Next, the configuration of a movable object 100 will be described with reference to FIG. 2. The movable object 100 includes a control unit 101, a storage unit 102, a communication unit 103, a camera unit 104, a sensor unit 105, a SLAM processing unit 106, a drive unit 107, a power supply unit 108, and a movable-object search unit 110. The movable-object search unit 110 includes an information acquisition unit 111, a hash generation unit 112, and a search processing unit 113.

The control unit 101 includes a CPU, a RAM, and a ROM. The CPU issued commands by executing various pieces of processing in accordance with such a program stored in the ROM to control the entire movable object 100 and each unit of the movable object 100. Further, the control unit 101 supplies, to the drive unit 107, a control signal for controlling output of the drive unit 107 to control, for example, the movement speed and the movement direction of the movable object 100.

The storage unit 102 is a large-capacity storage medium such as a hard disk or a flash memory. The storage unit 102 stores map data created by the SLAM processing unit 106, an image captured by the camera unit 104, and others such as data and an application necessary for use of the movable object 100.

The communication unit 103 is a communication module for communication with the server apparatus 300. Examples of the communication scheme include a wireless LAN, a WAN, WiFi, 4G, 5G, Bluetooth (registered trademark), and ZigBee (registered trademark).

The camera unit 104 includes a capturing element and an image processing engine, and has a function as a camera capable of capturing RGB or monochrome two-dimensional still images and moving images. The camera unit 104 may be included in the movable object 100 itself, or may be a device different from the movable object 100 and installable due to connection to the movable object 100.

The sensor unit 105 is a sensor such as a global positioning system (GPS) module capable of detecting the location of the movable object 100. The GPS is a system for receiving, through a receiver, signals from a plurality of artificial satellites around the earth and recognizing a current location.

Further, the sensor unit 105 may include a sensor such as an inertial measurement unit (IMU) module that detects an angular velocity. The IMU module is an inertial measurement device, and obtains three-dimensional angular velocity and acceleration with, for example, an accelerometer, an angular-velocity sensor, and a gyro sensor in two or three axial directions to detect the pose, orientation, and others of the movable object 100.

The SLAM processing unit 106 creates map data regarding the surroundings of the movable object 100 and performs self localization with the SLAM function. With SLAM, the SLAM processing unit 106 can create map data and can estimate a self location on the map data by use of a combination of the feature points detected from the image captured by the camera unit 104, the results of detection by the IMU, and others such as sensor information from the various sensors. The map data created by the SLAM processing unit 106 is transmitted to the information processing device 200 through the communication unit 103.

The drive unit 107 is a functional block that achieves the operation of the movable object in accordance with a predetermined operation instructed by the control unit 101. The drive unit 107 causes a motor or an actuator each as an operation part of the movable object 100 to operate to achieve the movement of the movable object 100. Note that the means of movement of the movable object 100 is different in the types of movable objects, and thus the means of movement of the movable object may be any means of movement in the present embodiment. Examples of the means of movement includes the operation of a rotary wing of a drone as a movable object 100, the rotation of a wheel of a robot vacuum cleaner, an automated driving vehicle, or an autonomous delivery robot as a movable object 100, or the operation of a foot of a pet robot or a humanoid robot as a movable object 100.

The power supply unit 108 supplies power to, for example, each electric circuit of the movable object 100. The movable object 100 is of the autonomous driving type using a battery. For example, the power supply unit 108 includes a rechargeable battery and a charge/discharge control unit that manages a charge/discharge state of the rechargeable battery.

The movable-object search unit 110 is for searching for another movable object.

The information acquisition unit 111 acquires information in use for hash value generation by the hash generation unit 112. In the present embodiment, time information and a network ID are used for the hash value generation. The time information can be acquired by use of a clock function normally included in the movable object 100. The network ID can be acquired by use of a communication function of the communication unit 103 included in the movable object 100. Examples of the network ID include a service set identifier (SSID) as the identification name of a Wi-Fi access point, and the ID of a cellular base station. Further, the information acquisition unit 111 acquires, as necessary, the intensity of radio waves from the network through which the network ID has been acquired. The intensity of radio waves may be acquired by use of the communication function of the communication unit 103, or may be acquired with a known application dedicated to acquisition of the intensity of radio waves.

The hash generation unit 112 generates a hash value on the basis of the time information and the network ID. The hash value is used for movable-object search processing by the search processing unit 113.

The search processing unit 113 searches, with the hash value generated by the hash generation unit 112, for another movable object present in the near range of the movable object 100. In the present embodiment, the map data created by the movable object 100 and map data created by the other movable object present in the near range are combined by the information processing device 200. Note that the near range is not limited to a specific range, and thus is determined by a range indicated by map data or a range to which another movable object is searched for.

When finding the other movable object, the movable object 100 transmits an image captured by the camera unit 104 to the information processing device 200 as a query image, inquires of the information processing device 200 about the captured location and captured pose of the query image on map data, and issues an instruction for combining the map data created by the movable object 100 and the map data created by the other movable object.

The movable-object search unit 110 is achieved due to execution of a program. The program may be installed in the movable object in advance, or may be distributed by, for example, downloading or a storage medium and may be installed by the user himself/herself. Further, the movable-object search unit 110 may be achieved not only due to the execution of the program but also with a combination of, for example, a dedicated device and a dedicated circuit based on hardware having the function of the movable-object search unit 110.

[1-3. Configuration of Information Processing Device 200]

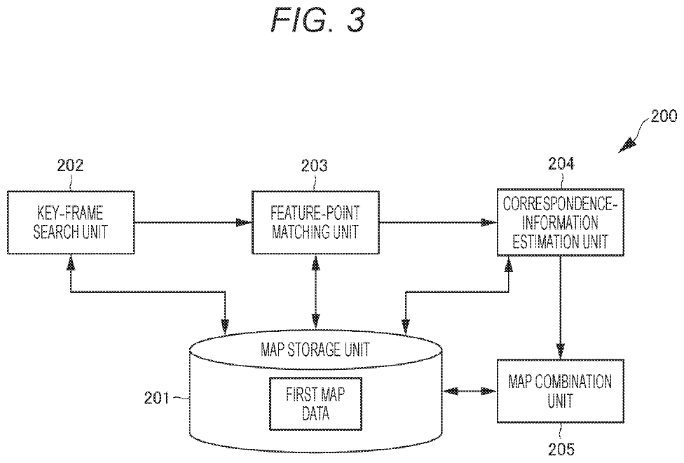

Next, the configuration of an information processing device 200 will be described with reference to FIG. 3. The information processing device 200 includes a map storage unit 201, a key-frame search unit 202, a feature-point matching unit 203, a correspondence-information estimation unit 204, and a map combination unit 205. The key-frame search unit 202, the feature-point matching unit 203, and the correspondence-information estimation unit 204 perform localization processing.

The map storage unit 201 is a storage unit that stores and saves map data. The map data may be created by the movable object 100 with SLAM or, for example, map data provided by an existing map database or a map service. In order that the information processing device 200 performs map combination processing, the map data is read from the map storage unit 201.

It is assumed that the origin O at a freely-selected location and xyz axes are set in advance on the map data. The respective locations of the query image and a key frame on the map data are specified on the basis of the deviation from the origin O, and the deviation and rotation between the query image and the key frame are calculated on the basis of the locations. Further, in combination of a plurality of pieces of map data, the plurality of pieces of map data needs to be identical in xyz axes. The origin O is a freely-selected point on the map data. For example, on the basis of the four cardinal directions, the directions of the xyz axes are defined as the east-west direction, the north-south direction, and the vertical direction.

The key frame is disposed in advance on the map data. The key frame is a representative image representing the environment in the map data, and includes information regarding the location and pose on the map data. A single key frame may be disposed on a single piece of map data, or a plurality of key frames may be disposed on a single piece of map data. The number of key frames is not limitative. The number of subjects in a key frame or the number of key frames may be determined in accordance with the size of the map data or an object in the real space corresponding to the map data. As the number of key frames is larger, the features in the real space corresponding to the map data can be more grasped, so that the accuracy of map data combination can be improved. For example, such a key frame is captured by the user with the movable object 100 and the information processing device 200 and is associated with map data in advance. The movable object 100 may add a key frame while performing the SLAM processing.

The key frame includes information regarding feature points. A feature point represents a feature of the key frame such as an object in the key frame that changes little even when environmental conditions such as time and weather change. Such feature points can be detected from the key frame with a conventional algorithm. Examples of the feature detection method include a corner detection method (Harris algorithm, features from accelerated segment test (FAST)), a feature-point detection method with a neural network, feature-point detection with deep learning, and a luminance gradient. It is assumed that a single key frame or a plurality of key frames is disposed in advance on the map data and the feature points have been detected in the single frame or each of the plurality of key frames. Note that the user may directly set a key frame and its feature points in addition to use of a known algorithm.

The key-frame search unit 202 searches for a key frame to be subjected to feature-point matching processing with the query image among the plurality of key frames disposed on the map data on the basis of the feature amount of each key frame. The feature amount of the key frame is supplied from the map storage unit 201 to the key-frame search unit 202. All the key frames may be sequentially compared with the query image, or a key frame to be subjected to comparison processing based on the features in the key frame may be selected to compare only the selected key frame with the query image. Information regarding the key frame to be subjected to the feature-point matching processing is supplied to the feature-point matching unit 203. In the following description, the feature-point matching processing with the query image is performed, and a key frame as a reference for specifying the location of the query image on the map data is referred to as a specific key frame.

The feature-point matching unit 203 performs the feature-point matching processing on the specific key frame that the key-frame search unit 202 has searched for and the query image. The feature points matched resulting from the comparison between the feature points of the specific key frame and the feature points of the query image are extracted, which enables estimation of correspondence information between the specific key frame and the query image by the correspondence-information estimation unit. The feature points of the specific key frame are supplied from the map storage unit 201 to the feature-point matching unit 203. The feature-point matching processing can be performed with a technique such as scale invariant feature transform (SIFT) or speed upped robust feature (SURF). The result of the feature-point matching processing is supplied to the correspondence-information estimation unit 204.

On the basis of the result of the feature-point matching processing and location-and-pose information regarding the specific key frame, the correspondence-information estimation unit 204 estimates the correspondence information between the specific key frame and the query image and the location and pose of the query image on the map data. The location-and-pose information regarding the specific key frame is supplied from the map storage unit 201 to the correspondence-information estimation unit 204.

The correspondence information includes the deviation (amount of movement) of the location of the query image on the map data from the location of the specific key frame on the map data, and the rotation of the pose of the query image on the map data with respect to the pose of the specific key frame on the map data. On the basis of the matching between the feature points of the specific key frame and the feature points of the query image, the location, deviation, and rotation of an object of the query image with respect to the key frame are grasped, resulting in acquisition of the correspondence information. As the correspondence information, the deviation of the location indicated by the query image from the location indicated by the key frame and the rotation of the pose indicated by the query image with respect to the pose indicated by the key frame can be acquired with reference to the origin O and the xyz axes set on the map data.

Note that the movable object 100 can estimate a self location on the map data with SLAM. Therefore, the movable object 100 may transmit together with the query image, to the information processing device 200, the information regarding the self location on the map data that matches the captured location of the query image, and the information processing device 200 may specify the location of the query image on the map data or create a map with the information regarding the self location.

The correspondence-information estimation unit 204 outputs the estimated location and pose of the query image on the map data as location-and-pose information. The location-and-pose information regarding the query image is transmitted to the movable object 100 having transmitted the query image.

The map combination unit 205 performs processing of combining a plurality of pieces of map data on the basis of the correspondence information between the plurality of pieces of map data and a query image in each of the plurality of pieces of map data.

The information processing device 200 is configured as described above. Note that the information processing device 200 is achieved due to execution of a program, and the program may be installed in, for example, a server apparatus in advance, or may be distributed by, for example, downloading or a storage medium and may be installed by the user himself/herself. Further, the information processing device 200 may be achieved not only due to the execution of the program but also with a combination of, for example, a dedicated device and a dedicated circuit based on hardware having the function of the information processing device 200.

[1-4. Processing in Movable Object 100]

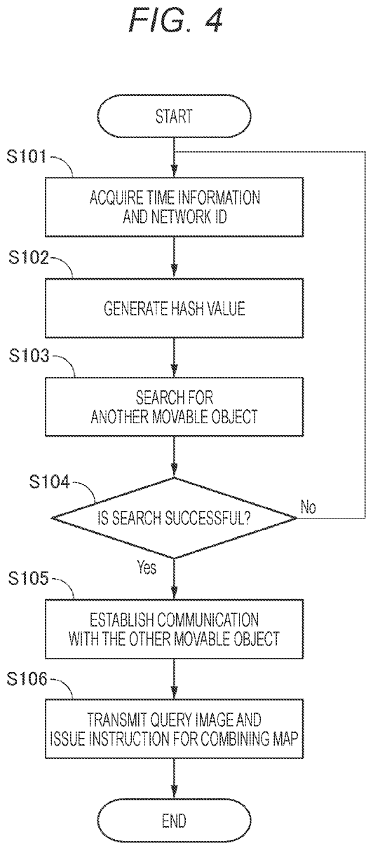

Next, processing in a movable object 100 will be described with reference to the flowchart of FIG. 4. Here, the description will be given assuming that the first movable object 100A finds the second movable object 100B by searching, and the first information processing device 200A associated with the first movable object 100A combines the first map data and the second map data. Thus, the following description is about processing in the first movable object 100A.

In the processing in the first movable object 100A, first, in step S101, the information acquisition unit 111 acquires current time information and a network ID.

Next, in step S102, the hash generation unit 112 generates a hash value on the basis of the time information and the network ID.

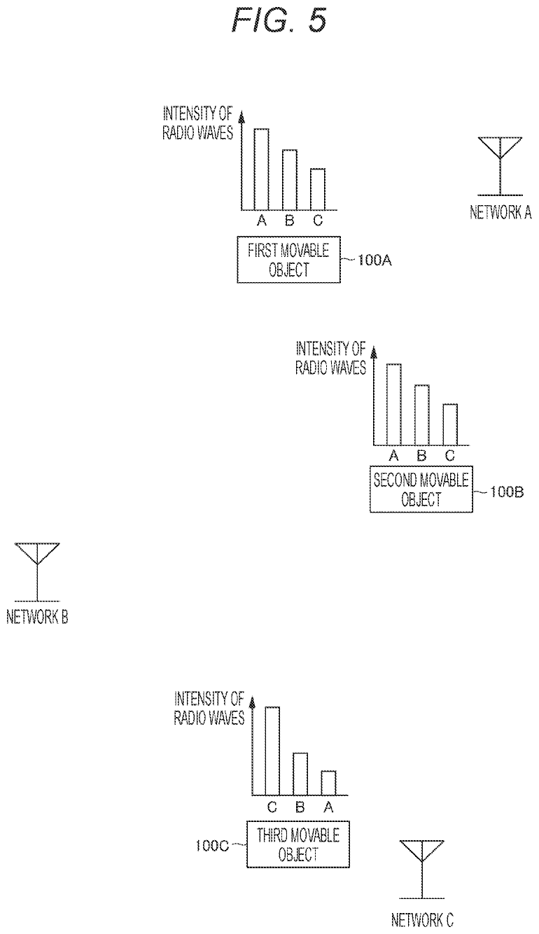

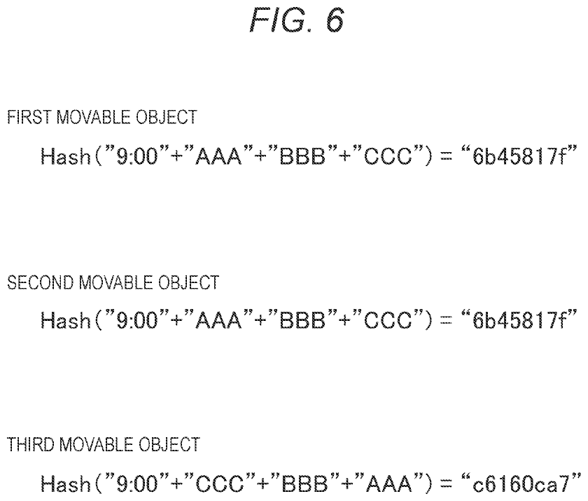

Here, the generation of the hash value will be described with reference to FIGS. 5 and 6. As an example, it is assumed that respective access points in a network A, a network B, and a network C are present as illustrated in FIG. 5.

The first movable object 100A acquires the respective network IDs of the network A, the network B, and the network C, and further acquires the intensity of radio waves from each network. Here, for convenience of description, the network ID of the network A, the network ID of the network B, and the network ID of the network C are defined as “AAA”, “BBB”, and “CCC”, respectively.

Next, the first movable object 100A sorts the networks in the order of the intensity of radio waves. The order of declining intensity of radio waves to the first movable object 100A is the network A, the network B, and the network C because the access point in the network A is closest to the first movable object 100A among the three networks.

Further, fraction-rounding processing (rounding processing) is performed on the acquired time information, and then, on the basis of the time information and the sorted network IDs, a hash value is generated with a predetermined hash function. The fraction-rounding processing is performed, for example, in units of 10 minutes. In that case, the result of the fraction-rounding processing is 9:00 in both cases where the time is 9:04 and 9:08. What the hash value calculated for each movable object 100 is the same is a condition for combining the map data. Thus, if the time information is slightly different, the hash values are different from each other, and the map data cannot be combined. Therefore, the fraction-rounding processing provides ranges to the condition of combining the map data, and it is not necessary that the respective timings of the hash value generation in the movable objects 100 are accurately synchronized with each other.

Because such a movable object 100 is often in a moving state, if a hash value is generated on the basis of older time information and a network ID, it is likely that the hash value does not correspond to the real-time location of the movable object 100. Thus, generation of a hash value and search for a movable object 100 may be performed at a short time interval to some extent (for example, 10 minutes).

The hash value of the first movable object 100A is obtained by calculating from the time information and the sorted network IDs as illustrated in FIG. 6. Similarly, the second movable object 100B generates a hash value. Further, for the sake of description, it is assumed that a third movable object 100C is present, and the third movable object 100C similarly generates a hash value.

The order of increasing distance from the access point to the first movable object 100A and the second movable object 100B is the network A, the network B, and the network C. Thus, the sorting order of the network IDs based on the intensity of radio waves is the same as the above order as illustrated in FIG. 5. However, the order of declining intensity of radio waves to the third movable object 100C is the network C, the network B, and the network A because the access point in the network C is closest to the third movable object 100C among the three networks. Therefore, the sorting order of the network IDs by the third movable object 100C is different from those by the first movable object 100A and the second movable object 100B. Note that such sorting is not limited to the order of the intensity of radio waves, and thus may be another order, for example, a dictionary order.

Similarly, each of the hash value of the second movable object 100B and the hash value of the third movable object 100C is also calculated from the time and the sorted network IDs as illustrated in FIG. 6. Note that each hash value indicated in FIG. 6 is assumed as an example for convenience of description, and thus is not an actual hash value.

Because the first movable object 100A and the second movable object 100B are the same in the time information and the sorting order of the network IDs based on the intensity of radio waves, the hash values are the same. However, the sorting order of the network IDs by the third movable object 100C is different from those of the first movable object 100A and the second movable object 100B. Thus, the hash value of the third movable object 100C is not the same as those of the first movable object 100A and the second movable object 100B.

The description returns to the flowchart. Next, in step S103, on the basis of the hash value, the movable-object search unit 110 searches for another movable object present in the near range of the first movable object 100A.

For searching for another movable object, the movable-object search unit 110 broadcasts the hash value generated by the hash generation unit 112 to another movable object present around the first movable object 100A and inquires as to whether the other movable object has the same hash value as that of the first movable object 100A. The other movable object received the inquiry transmits a response to the first movable object 100A having made the inquiry as to whether or not the received hash value and the hash value generated by the other movable object are the same. Thus, it needs that the other movable object has also generated the hash value by the same method.

Note that, in a case where a management server that centrally manages the hash values transmitted from all the movable objects 100 under management together with the identification information regarding the movable objects 100 as transmission sources is present, another movable object 100 can also be searched for by another method. The first movable object 100A transmits the hash value generated by itself to the management server, and inquires as to whether a movable object having transmitted the same hash value to the management server, so that the first movable object 100A can also search for another movable object. Note that the management server stores all the hash values transmitted together with the inquiries and uses the hash values for checking the presence or absence of a hash value for the subsequent inquiry from another movable object.

Next, in a case where the search for the other movable object is successful in step S104, that is, in a case where a movable object having the same hash value is present, the processing goes to step S105 (Yes in step S104). Otherwise, in a case where the search is failed, that is, in a case where no movable object having the same hash value is present, the processing goes to step S101, and steps S101 to S104 are repeated (No in step S104). Here, it is assumed that the second movable object 100B is found as the other movable object.

Next, in step S105, the first movable object 100A establishes communication with the second movable object 100B as the other movable object, and acquires the identification information regarding the second server apparatus 300B (second information processing device 200B) storing the second map data created by the second movable object 100B. As a result, the first movable object 100A can transmit a query image to the second information processing device 200B.

Next, in step S106, the first movable object 100A transmits the query image to the first information processing device 200A, and inquires about the location-and-pose information regarding the query image on the first map data. Further, the first movable object 100A transmits the query image to the second information processing device 200B corresponding to the second movable object 100B, and inquires about the location and pose of the query image on the second map data.

Furthermore, the first movable object 100A transmits, to the first information processing device 200A, an instruction for combining the first map data stored in the first information processing device 200A and the second map data stored in the second information processing device 200B. At this time, the first movable object 100A transmits, to the first information processing device 200A, information indicating that the second information processing device 200B associated with the second movable object 100B has the second map data. As a result, the first information processing device 200A can establish communication with the second information processing device 200B, which enables transmission and reception of information necessary for combining the map data.

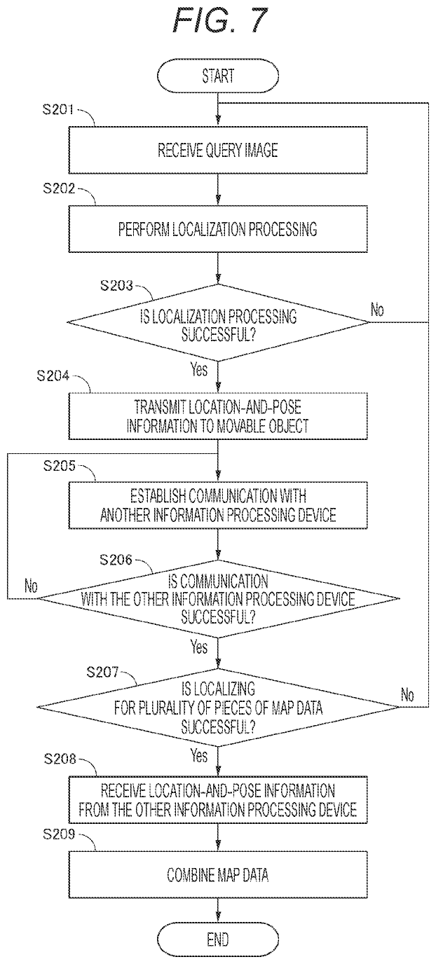

The processing in the movable object 100 is performed as described above. According to the present technology, a network ID is used for searching for another movable object, but only the hash value is disclosed. Thus, it is unlikely to externally leak the location information regarding the movable object 100 due to the network ID. Further, even if the hash value is intercepted, an enormous amount of calculation is required to obtain the network ID from the hash value. Thus, it is less likely to leak the network ID. Furthermore, the hash value can be transmitted to a key-value store service on the network to search for another movable object.

[1-5. Processing in Information Processing Device] Next, processing in an information processing device 200 will be described with reference to the flowchart of FIG. 7. The above processing in the movable object 100 is processing of checking that the second movable object 100B is present in the near range of the first movable object 100A, transmitting a query image, and issuing an instruction for map data combination. At that stage, it is unclear whether the first map data created by the first movable object 100A and the second map data created by the second movable object 100B can be combined.

The information processing device 200 determines whether or not the first map data and the second map data can be combined, and in a case where the first map data and the second map data can be combined, the first map data and the second map data are combined to form a single piece of map data.

First, in step S201, the first information processing device 200A receives the query image transmitted from the first movable object 100A, and accepts the inquiry about the location-and-pose information regarding the query image on the first map data and the instruction for combining the map data.

Next, in step S202, the first information processing device 200A performs localization processing on the query image and the first map data transmitted from the first movable object 100A. As a result, the location and pose of the query image on the first map data and correspondence information between the query image and a specific key frame are acquired. Note that the second information processing device 200B similarly performs localization processing on the query image and the second map data transmitted from the first movable object 100A.

In a case where the localization processing is successful, the processing goes to step S204 (Yes in step S203). Otherwise, in a case where the localization processing is failed, the processing returns to step S201 (No in step S203).

Next, in step S204, the first information processing device 200A transmits estimated location-and-pose information regarding the query image to the first movable object 100A having made the inquiry by transmitting the query image. As a result, the first movable object 100A can recognize that the first movable object 100A has captured the query image at which location and in what pose on the map data.

Next, in step S205, the first information processing device 200A transmits a request for communication to the second information processing device 200B to establish the communication with the second information processing device 200B.

Next, in step S206, the first information processing device 200A checks whether the communication is established with the second information processing device 200B having the second map data. Steps S205 and S206 are continued until communication with the second information processing device 200B is established.

Next, in step S207, the first information processing device 200A check whether or not the localization processing based on the same query image is successful by each of the first information processing device 200A and the second information processing device 200B. Thus, the first information processing device 200A needs to receive a notification as to whether or not the localization processing is successful from the second information processing device 200B. The first information processing device 200A combines a plurality of pieces of map data on the basis of a query image. Thus, in order to combining the map data, needed is a success in localization processing on the first map data and the second map data based on the same query image. In a case where the localization processing on the first map data and the second map data based on the same query image is successful, the first information processing device 200A determines that the first map data and the second map data can be combined, and the processing goes to step S207 (Yes in step S207).

Next, in step S208, the first information processing device 200A receives correspondence information regarding the query image on the second map data from the second information processing device 200B. Note that the correspondence information regarding the query image on the second map data may be transmitted and received by communication through the first movable object 100A, instead of by direct communication between the server apparatuses. However, it is considered that the direct communication between the server apparatuses is better in terms of efficiency in communication and security.

Then, in step S209, the first information processing device 200A performs combination processing on the first map data and the second map data on which the localization processing is successful.

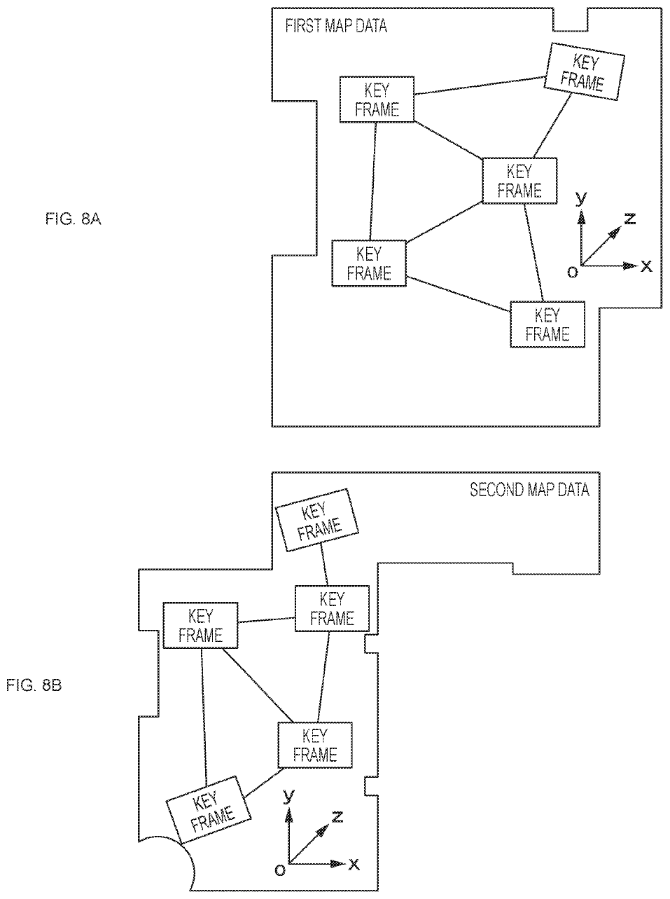

Here, map-data combination processing will be described with reference to FIGS. 8 to 12. The description is given assuming that the first map data is that illustrated in FIG. 8A and the second map data is that illustrated in FIG. 8B. The first map data and the second map data are each associated with the corresponding origin O and xyz axes.

As illustrated in FIG. 8A, it needs to dispose a plurality of key frames on the first map data in advance. Further, as illustrated in FIG. 8B, it needs to dispose a plurality of key frames on the second map data in advance.

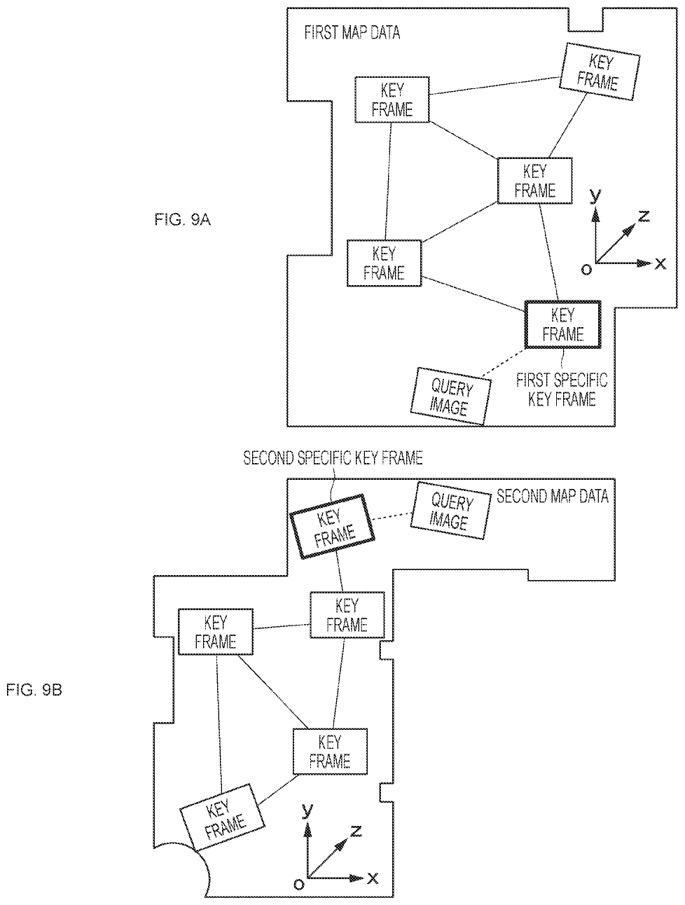

Then, as illustrated in FIG. 9A, when the location of a query image on the first map data is specified by the localization processing, correspondence information between a specific key frame and the query image on the first map data can be acquired. The specific key frame on the first map data is referred to as a first specific key frame.

Similarly, as illustrated in FIG. 9B, when the location of a query image on the second map data is specified by the localization processing, correspondence information between a specific key frame and the query image on the second map data can be acquired. The specific key frame on the second map data is referred to as a second specific key frame.

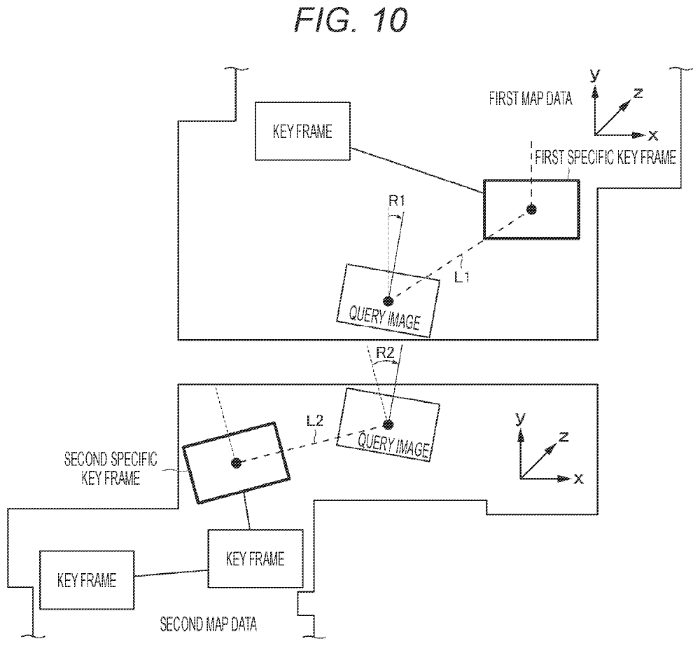

As illustrated in FIG. 10, on the first map data, the correspondence information includes the deviation L1 of the location indicated by the query image on the map data from the location indicated by the first specific key frame on the map data, and the rotation (angle R1) of the pose indicated by the query image on the map data with respect to the pose indicated by the first specific key frame on the map data. The angle R1 is obtained with reference to, for example, any of the xyz axes preset on the first map data.

Further, as illustrated in FIG. 10, on the second map data, the correspondence information includes the deviation L2 of the location indicated by the query image on the map data from the location indicated by the second specific key frame on the map data, and the rotation (angle R2) of the pose indicated by the query image on the map data with respect to the pose indicated by the second specific key frame on the map data. Similarly to the angle R1, the angle R2 is obtained with reference to any of the xyz axes preset on the second map data.

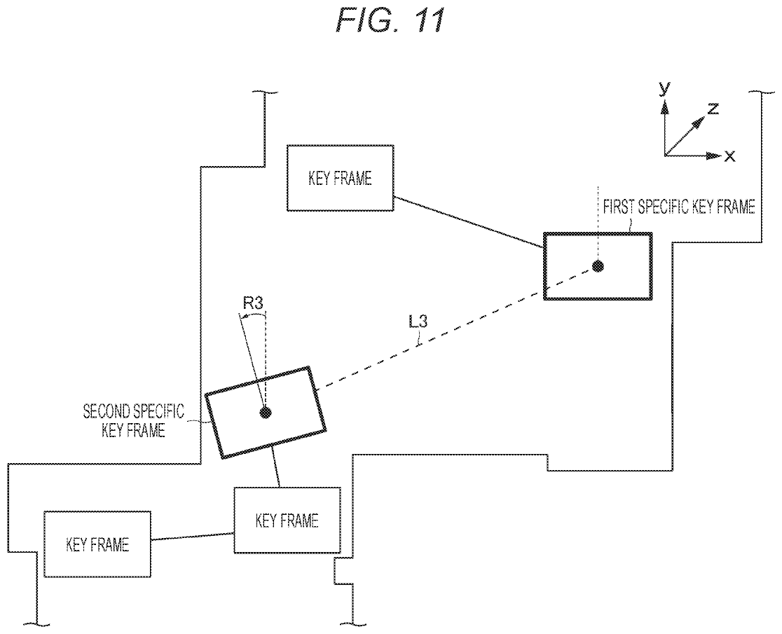

Note that, in FIGS. 10 and 11, the deviation L and the angle R are calculated with reference to the approximate centers of the first specific key frame, the second specific key frame, and the query images, which are set for convenience of illustration and description. In practice, the deviation L and the angle R are calculated with reference to the respective locations indicated by the first specific key frame, the second specific key frame, and the query images on the map data.

The query image disposed on the first map data and the query image disposed on the second map data are the same and represent the same location and pose in the real space. Thus, in a case where the correspondence information between the first map data and the query image and the correspondence information between the second map data and the query image can be acquired by the localization processing, the correspondence relationship (relative relationship) between the first map data and the second map data can be acquired on the basis of the location of the query image on the first map data and location of the query image on the second map data.

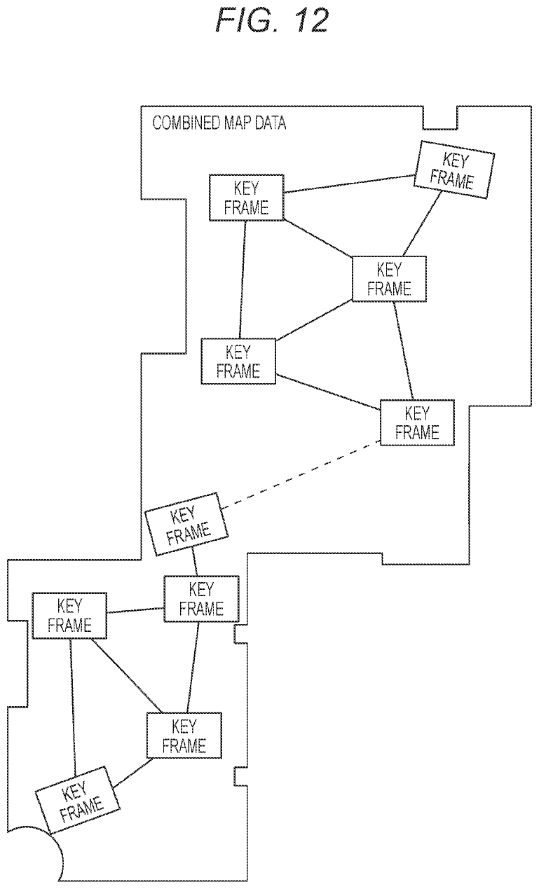

As illustrated in FIG. 11, the correspondence relationship (relative relationship) between the first map data and the second map data is indicated by the deviation L3 of the second specific key frame on the second map data from the first specific key frame on the first map data, and the rotation (angle R3) of the second specific key frame on the second map data with respect to the first specific key frame on the first map data. As a result, as illustrated in FIG. 12, a single piece of combined map data can be created by combining the first map data and the second map data.

Note that correspondence information between a query image and a key frame can also be represented by three-dimensional coordinates with reference to the location of the key frame. Further, the pose (orientation) of the query image with respect to the key frame can also be represented by a matrix.

In the present embodiment, the description has been given of combination of two-dimensional map data. The present technology is also applicable to combination of three-dimensional map data.

The processing in the information processing device 200 is performed as described above. According to the present technology, combination of a plurality of pieces of map data results in creation of larger map data. In addition, the plurality of pieces of map data is combined on the basis of a single query image, which facilitates combination of the map data. The combination of the map data enables a movable object 100 to use the map data created by another movable object, and the movable object 100 can also cause the other movable object to use the map data created by the movable object 100. Acquired can also be map data for a region where the movable object 100 has not travelled. Further, the respective locations of a plurality of movable objects can be estimated on a single piece of combined map data, so that the plurality of movable objects can operate in cooperation by exchanging their location information with each other.

### 2. Modifications

The embodiment of the present technology has been specifically described above. The present technology, however, is not limited to the above embodiment, and thus various modifications based on the technical idea of the present technology can be made.

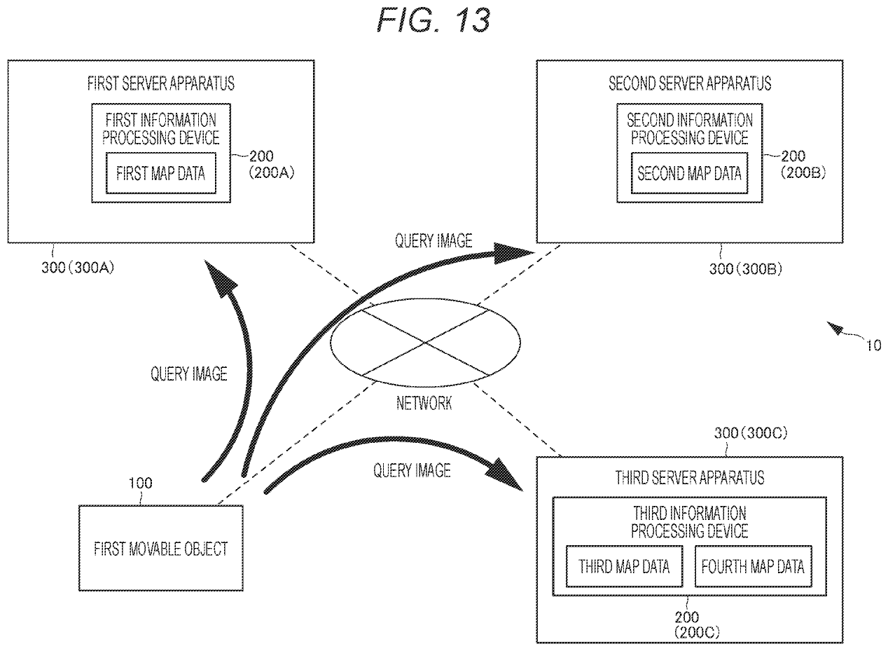

In the embodiment, the combination of the two pieces of map data stored in the two information processing devices 200 has been described as an example: however, the number of pieces of map data and the combination are not limited thereto. For example, as illustrated in FIG. 13, it is assumed that three information processing devices of a first information processing device 200A, a second information processing device 200B, and a third information processing device 200C are provided, and further the third information processing device 200C stores two pieces of map data. In this case, a movable object 100 can transmit a query image to all the three information processing devices 200 and can issue an instruction for map data combination. For example, the third information processing device 300C can combine a third map data and a fourth map data. Further, any of the information processing devices 200 can combine a first map data, a second map data, and the combined map data including the third map data and the fourth map data to create a single piece of combined map data including a total of four pieces of map data.

In the embodiment, the first information processing device 200A stores the first map data, and the second information processing device 200B stores the second map data. A single information processing device 200, however, may store a plurality of pieces of map data. In a case where a single information processing device 200 stores a plurality of pieces of map data, localization processing is sequentially performed on the plurality of pieces of map data, and map data to be combined is selected.

Further, in the embodiment, the first movable object 100A transmits a query image to the first information processing device 200A and the second information processing device 200B to issue an instruction for map data combination. However, in addition to the first movable object 100A, the second movable object 100B may transmit a query image to the first information processing device 200A and the second information processing device 200B. Localization processing is performed with the query image from the first movable object 100A and localization processing is performed with the query image from the second movable object 100B, so that the accuracy of map data combination can be enhanced.

In addition, without a server apparatus 300, the first movable object 100A may have a function as the first information processing device 200A and may store the first map data, and the second movable object 100B may have a function as the second information processing device 200B and may store the second map data. In this case, the movable object 100 that transmits a query image needs to perform localization processing on the map data and the query image stored in the movable object 100 itself.

Further, similarly to the embodiment, a plurality of pieces of map data stored in a single information processing device 200 associated with a single movable object 100 can be subjected to map data combination. Furthermore, similarly to the embodiment, a plurality of pieces of map data stored in a single movable object 100 having a function as an information processing device 200 can be subjected to map data combination. That is, the number of movable objects and the number of information processing devices are not limited if a plurality of pieces of map data is present.

An information processing device 200 may import a query image to map data to expand the map data.

In addition to a server apparatus 300 described in the embodiment, an information processing device 200 may operate in a movable object 100, may operate in a terminal device such as a personal computer, a smartphone, or a tablet terminal, or may operate on a cloud.

A plurality of movable objects 100 may be present, and a plurality of pieces of map data created one-to-one by the plurality of movable objects 100 may be stored in a single common information processing device 200.

Further, not through another device such as a server apparatus 300, an information processing device 200 may have a communication function and may communicate with a movable object 100.

A query image is not necessarily captured by a camera included in the movable object 100 having created map data, and for example, an image captured by the user with a terminal device or the like may be transmitted to an information processing device 200 as a query image.

The user can specify at least two pieces of map data, prepare a query image, and cause an information processing device 200 to combine the map data. Thus, the presence of a movable object 100 is not essential in the map data combination.

In the embodiment, the description is given in which two pieces of map data of the first map data and the second map data are combined. The number of pieces of map data to be combined, however, is not limited to two, and thus may be three or more. Thus, the number of movable objects, the number of information processing devices, and the number of server apparatuses may be each three or more.

The present technology can also adopt the following configurations.

(1)

An information processing device configured to:

acquire correspondence information between a key frame and a query image, the key frame being disposed in advance on map data; and

combine a plurality of pieces of the map data on the basis of the correspondence information.

(2)

The information processing device according to (1) described above, in which the key frame corresponds to a captured image of a real space represented by the map data.

(3)

The information processing device according to (1) or (2) described above, in which the correspondence information includes a deviation of a location indicated by the query image on the map data from a location indicated by the key frame on the map data.

(4)

The information processing device according to any of (1) to (3) described above, in which the correspondence information includes a rotation of a pose indicated by the query image on the map data with respect to a pose indicated by the key frame on the map data.

(5)

The information processing device according to any of (1) to (4) described above, in which in a case where a plurality of the key frames is present on the map data, the information processing device specifies, with feature-point matching between each of the plurality of the key frames and the query image, one of the plurality of the key frames for acquisition of the correspondence information.

(6)

The information processing device according to any of (1) to (5) described above, in which the information processing device combines the plurality of pieces of the map data on the basis of a relative relationship between the respective pieces of feature information based on the plurality of pieces of the map data.

(7)

The information processing device according to any of (1) to (6) described above, in which the map data is acquired due to simultaneous localization and mapping (SLAM) on the basis of movement of a movable object.

(8)

The information processing device according to (7) described above, in which in a case where the plurality of pieces of the map data is acquired one-to-one by a plurality of the movable objects present within a near range, the information processing device combines the plurality of pieces of the map data.

(9)

The information processing device according to (8) described above, in which determination of whether or not the plurality of the movable objects is present within the near range is performed on the basis of a hash value.

(10)

The information processing device according to (9) described above, in which in a case where a hash value generated by one of the plurality of the movable objects is identical to a hash value generated by another of the plurality of the movable objects, the one of the plurality of the movable objects and the another of the plurality of the movable objects are determined as being present in the near range.

(11)

The information processing device according to (9) described above, in which the hash value is generated on the basis of time information and a network ID.

(12)

The information processing device according to (7) described above, in which the query image is transmitted from the movable object.

(13)

The information processing device according to (12) described above, in which the query image is transmitted, from the movable object, together with an inquiry about location information regarding the query image on the map data.

(14)

The information processing device according to (13), in which the information processing device transmits, to the movable object having transmitted the query image, the location information regarding the query image on the map.

(15)

An information processing method including:

acquiring correspondence information between a key frame and a query image, the key frame being disposed in advance on map data; and

combining a plurality of pieces of the map data on the basis of the correspondence information.

(16)

An information processing program for causing a computer to perform an information processing method including:

acquiring correspondence information between a key frame and a query image, the key frame being disposed in advance on map data; and

combining a plurality of pieces of the map data on the basis of the correspondence information.

### REFERENCE SIGNS LIST

100 Movable object
200 Information processing device

1. An information processing device configured to:
acquire correspondence information between a key frame and a query image, the key frame being disposed in advance on map data; and
combine a plurality of pieces of the map data on a basis of the correspondence information.

2. The information processing device according to claim 1,
wherein the key frame corresponds to a captured image of a real space represented by the map data.

3. The information processing device according to claim 1,
wherein the correspondence information includes a deviation of a location indicated by the query image on the map data from a location indicated by the key frame on the map data.

4. The information processing device according to claim 1,
wherein the correspondence information includes a rotation of a pose indicated by the query image on the map data with respect to a pose indicated by the key frame on the map data.

5. The information processing device according to claim 1,
wherein in a case where a plurality of the key frames is present on the map data, the information processing device specifies, with feature-point matching between each of the plurality of the key frames and the query image, one of the plurality of the key frames for acquisition of the correspondence information.

6. The information processing device according to claim 1,
wherein the information processing device combines the plurality of pieces of the map data on a basis of a relative relationship between the respective pieces of feature information based on the plurality of pieces of the map data.

7. The information processing device according to claim 1,
wherein the map data is acquired due to simultaneous localization and mapping (SLAM) on a basis of movement of a movable object.

8. The information processing device according to claim 7,
wherein in a case where the plurality of pieces of the map data is acquired one-to-one by a plurality of the movable objects present within a near range, the information processing device combines the plurality of pieces of the map data.

9. The information processing device according to claim 8,
wherein determination of whether or not the plurality of the movable objects is present within the near range is performed on a basis of a hash value.

10. The information processing device according to claim 9,
wherein in a case where a hash value generated by one of the plurality of the movable objects is identical to a hash value generated by another of the plurality of the movable objects, the one of the plurality of the movable objects and the another of the plurality of the movable objects are determined as being present in the near range.

11. The information processing device according to claim 9,
wherein the hash value is generated on a basis of time information and a network ID.

12. The information processing device according to claim 7,
wherein the query image is transmitted from the movable object.

13. The information processing device according to claim 12,
wherein the query image is transmitted, from the movable object, together with an inquiry about location information regarding the query image on the map data.

14. The information processing device according to claim 13,
wherein the information processing device transmits, to the movable object having transmitted the query image, the location information regarding the query image on the map.

15. An information processing method comprising:
acquiring correspondence information between a key frame and a query image, the key frame being disposed in advance on map data; and
combining a plurality of pieces of the map data on a basis of the correspondence information.

16. An information processing program for causing a computer to perform an information processing method comprising:
acquiring correspondence information between a key frame and a query image, the key frame being disposed in advance on map data; and
combining a plurality of pieces of the map data on a basis of the correspondence information.
